(19) United States
(12) Patent Application Publication
(10) Pub. No.: US 2026/0351890 A1
(43) Pub. Date: Nov. 5, 2026

(54) CONNECTOR ASSEMBLY AND ITS CABLE-END CONNECTOR ASSEMBLY AND BOARD-END CONNECTOR ASSEMBLY

(71) Applicant: BIZLINK INTERNATIONAL CORP., New Taipei City (TW)

(72) Inventors: Zhongming LIN, New Taipei City (TW); Zihao CHEN, New Taipei City (TW)

(21) Appl. No.: 19/661,704

(22) Filed: Apr. 29, 2026

(30) Foreign Application Priority Data
Apr. 30, 2025 (CN) 202510569969.9
Apr. 30, 2025 (CN) 202520861962.X

(51) Int. Cl. H01R 13/512; H01R 12/79; H01R 13/633

(52) U.S. Cl. CPC H01R 13/512; H01R 12/79; H01R 13/633

(57) ABSTRACT

A cable-end connector assembly includes a housing, a plurality of terminals, at least one engaging groove, and at least one limiting member. The housing includes a front portion, a surrounding wall portion, and a plurality of protruding insulating portions disposed on the front portion. A slot is defined between the surrounding wall portion and the protruding insulating portions. The terminals are respectively disposed within the protruding insulating portions. The engaging groove is disposed on a side of the surrounding wall portion adjacent to the slot. The limiting member is disposed at the front portion of the housing and is movably received in the slot.

This application claims priority to China Application Serial Number 202520861962.X and 202510569969.9, filed Apr. 30, 2025, which is herein incorporated by reference in its entirety.

### BACKGROUND

### FIELD OF INVENTION

The present disclosure relates to a connector assembly, including its cable-end connector assembly and board-end connector assembly. More particularly, the present disclosure relates to a connector assembly, and its cable-end connector assembly and board-end connector assembly, which are reliably mated and easy to assemble and disassemble.

### DESCRIPTION OF RELATED ART

As computing demands increase, the power requirements of electronic devices also rise, making the stability of the connection between cable-end connector assemblies and board-end connector assemblies a crucial issue.

Taking a conventional connector assembly as an example, a connection point between the cable-end connector and the board-end connector is located on the outside of the connector assembly and is connected via a snap-fit mechanism. However, this fixing method tends to occupy external space of the connector assembly and has the drawback of being prone to separation and loosening.

Accordingly, providing a connector assembly and its cable-end connector assembly and board-end connector assembly that can solve the aforementioned problems has become an important issue for those skilled in the industry.

### SUMMARY

An aspect of the disclosure is to provide a connector assembly, including its cable-end connector assembly and board-end connector assembly, which can efficiently address the aforementioned problems.

According to an embodiment of the disclosure, a cable-end connector assembly includes a housing, a plurality of terminals, at least one engaging groove, and at least one limiting member. The housing includes a front portion, a surrounding wall portion, and a plurality of protruding insulating portions disposed on the front portion. A slot is defined between the surrounding wall portion and the protruding insulating portions. The terminals are respectively disposed within the protruding insulating portions. The engaging groove is disposed on a side of the surrounding wall portion adjacent to the slot. The limiting member is disposed at the front portion of the housing and is movably received in the slot.

According to an embodiment of the disclosure, a board-end connector assembly includes a panel, a housing, a plurality of terminal passages, a plurality of terminals, at least one engaging member, and at least one hook. The housing is disposed on the panel. The terminal passages are defined in the housing. The terminals are disposed within the terminal passages respectively and extend through the housing. The engaging member is disposed on a side of the housing adjacent to the panel. The engaging member has an arm facing the housing. The hook is located on a side of the engaging member distal from the housing.

According to an embodiment of the disclosure, a connector assembly includes a cable-end connector assembly and a board-end connector assembly. The cable-end connector assembly includes a cable-end housing, a plurality of cable-end terminals, at least one engaging groove, and at least one limiting member. The cable-end housing includes a front portion, a surrounding wall portion, and a plurality of protruding insulating portions disposed on the front portion. A slot is defined between the surrounding wall portion and the protruding insulating portions. The cable-end terminals are respectively disposed within the protruding insulating portions. The engaging groove is disposed on a side of the surrounding wall portion adjacent to the slot. The limiting member is disposed at the front portion of the cable-end housing and is movably received in the slot. The board-end connector assembly is configured to be inserted into the cable-end connector assembly and includes a panel, a board-end housing, a plurality of terminal passages, a plurality of board-end terminals, at least one engaging member, and at least one hook. The board-end housing is disposed on the panel. The terminal passages are defined in the board-end housing. The board-end terminals are disposed within the terminal passages respectively and extend through the board-end housing. The engaging member is disposed on a side of the board-end housing adjacent to the panel. The engaging member has an arm facing the board-end housing. The hook is located on a side of the at least one engaging member distal from the board-end housing and is configured to detachably hook the engaging groove. When the hook is located in the engaging groove, the engaging member is located between the limiting member and the engaging groove.

Accordingly, in the connector assembly and its cable-end connector assembly and board-end connector assembly of the present disclosure, by setting the engaging groove and the engaging member in the slot, the external operating space of the connector assembly may be increased. Therefore, multiple connector assemblies may be densely arranged when they are simultaneously plugged into an electronic device. By using the pull ring and the pull bar connected to the limiting member, the space behind the connector assembly may be used to separate the cable-end connector assembly and the board-end connector assembly.

It is to be understood that both the foregoing general description and the following detailed description are exemplary and are intended to provide further explanation of the disclosure as claimed.

### BRIEF DESCRIPTION OF THE DRAWINGS

The disclosure can be more fully understood by reading the following detailed description of the embodiments with reference to the accompanying drawings, as follows:

FIG. 1 is a perspective view of a connector assembly according to an embodiment of the present disclosure;

FIG. 2 is an exploded view of the connector assembly in FIG. 1;

FIG. 3 is a front perspective view of a cable-end connector assembly in FIG. 1;

FIG. 4 is a rear perspective view of a board-end connector assembly in FIG. 1;

FIG. 5 is a cross-sectional view of the connector assembly taken along section line A-A in FIG. 1;

FIG. 6 is an exploded view of the connector assembly in FIG. 5; and

FIGS. 7A-7D are cross-sectional views of the connector assembly taken along section line B-B in FIG. 1, illustrating operation steps for engaging the cable-end connector assembly with the board-end connector assembly.

### DETAILED DESCRIPTION

Reference will now be made in detail to the present embodiments of the disclosure, examples of which are illustrated in the accompanying drawings. Wherever possible, the same reference numerals are used in the drawings and the description to refer to the same or like parts. However, specific structural and functional details disclosed herein are merely representative for purposes of describing example embodiments, and thus may be embodied in many alternative forms and should not be construed as being limited to only the example embodiments set forth herein. Therefore, it should be understood that there is no intent to limit the example embodiments to the particular forms disclosed; on the contrary, the example embodiments are intended to cover all modifications, equivalents, and alternatives falling within the scope of the disclosure.

To help readers better understand the interrelationships and orientations of the various components, the drawings indicate coordinate axes including an X-axis, a Y-axis, and a Z-axis. Furthermore, the X-axis, the Y-axis, and the Z-axis are perpendicular to each other.

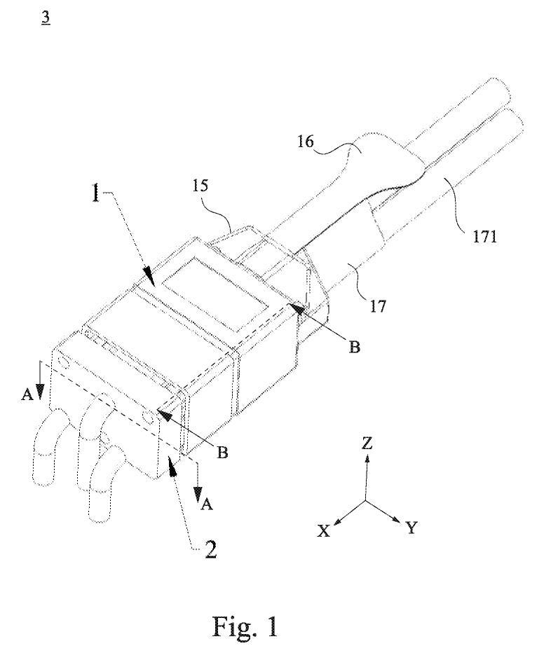

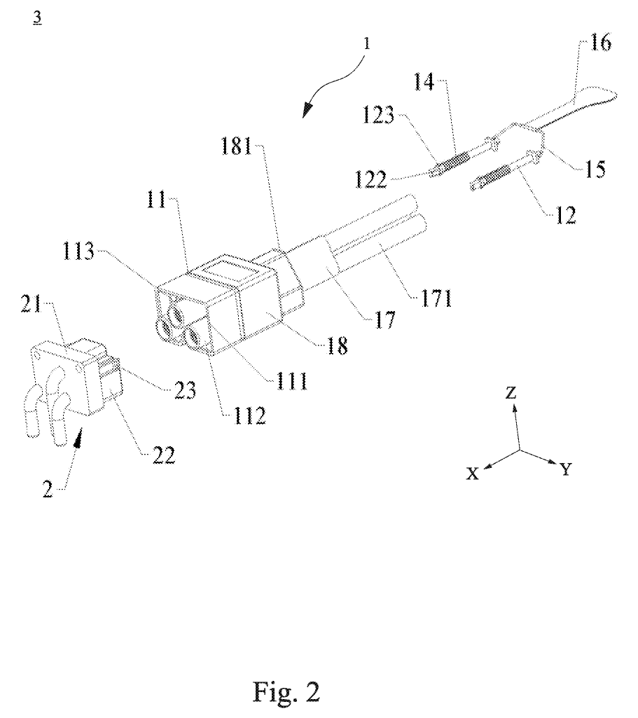

Reference is made to FIGS. 1 and 2. FIG. 1 is a perspective view of a connector assembly 3 according to an embodiment of the present disclosure. FIG. 2 is an exploded view of the connector assembly 3 in FIG. 1. As shown in FIGS. 1 and 2, in the present embodiment, the connector assembly 3 includes a cable-end connector assembly 1 and a board-end connector assembly 2, and the board-end connector assembly 2 is configured to be detachably inserted into the cable-end connector assembly 1.

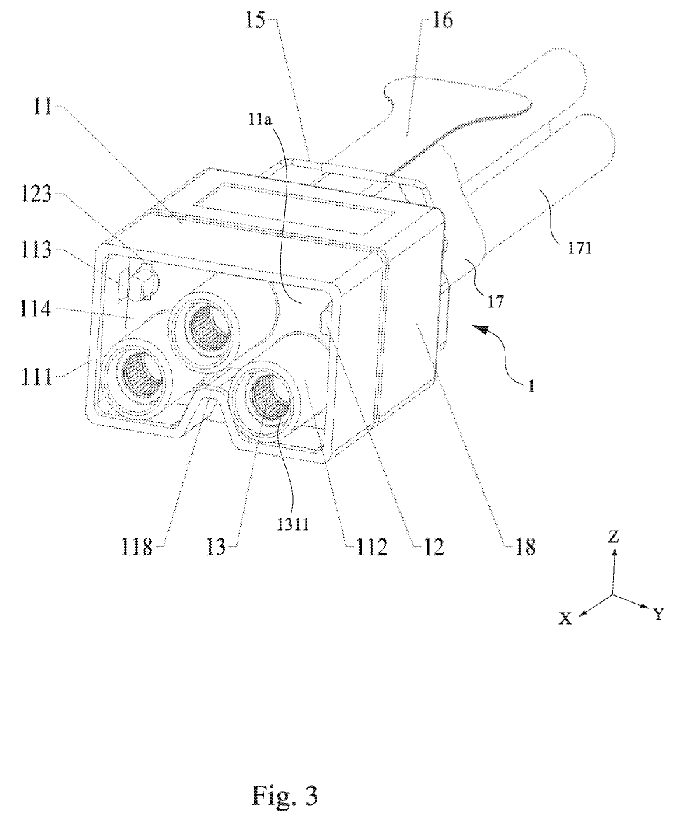

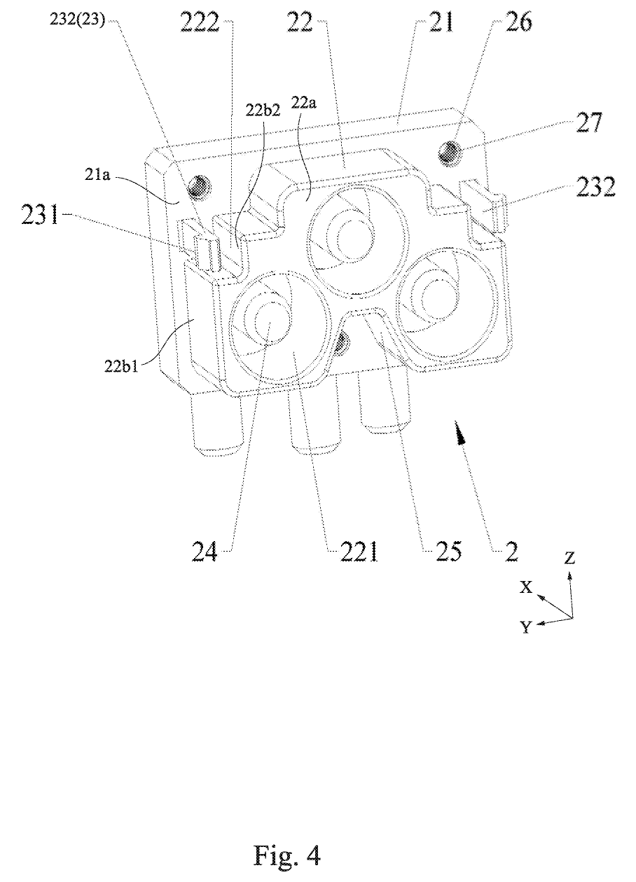

Reference is made to FIG. 3. FIG. 3 is a front perspective view of the cable-end connector assembly 1 in FIG. 1. As shown in FIGS. 2 and 3, in the present embodiment, cable-end connector assembly 1 includes a housing 11 and terminals 13. Specifically, the housing 11 includes a front portion 11a, a surrounding wall portion 111, and protruding insulating portions 112 which are disposed on the front portion 11a. The surrounding wall portion 111 surrounds the protruding insulating portions 112. A slot 114 is defined between the surrounding wall portion 111 and the protruding insulating portions 112. In the present embodiment, the terminals 13 are respectively disposed within the protruding insulating portions 112 and are configured to connect each of cables 171 of a cable bundle 17 and terminals 24 (see FIG. 4) of the board-end connector assembly 2.

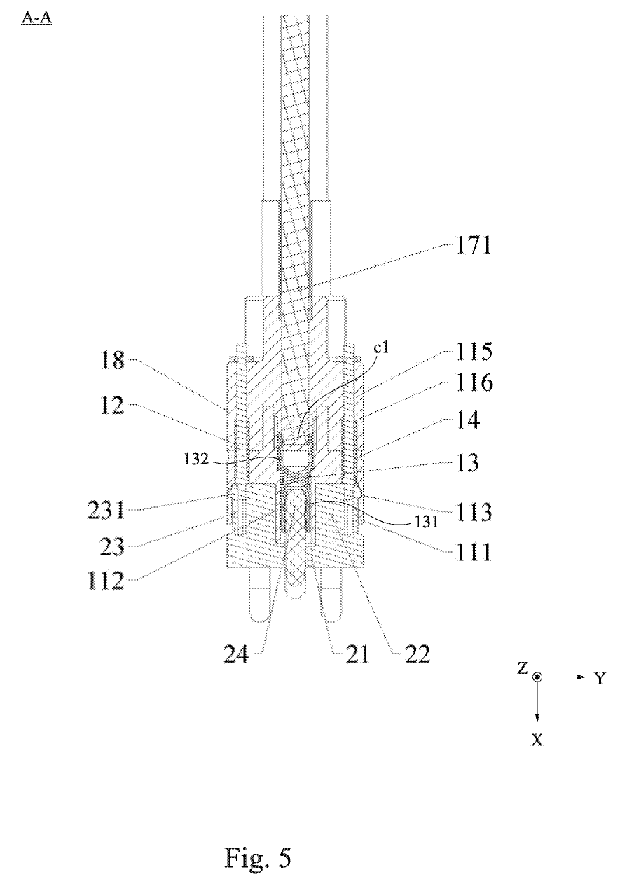

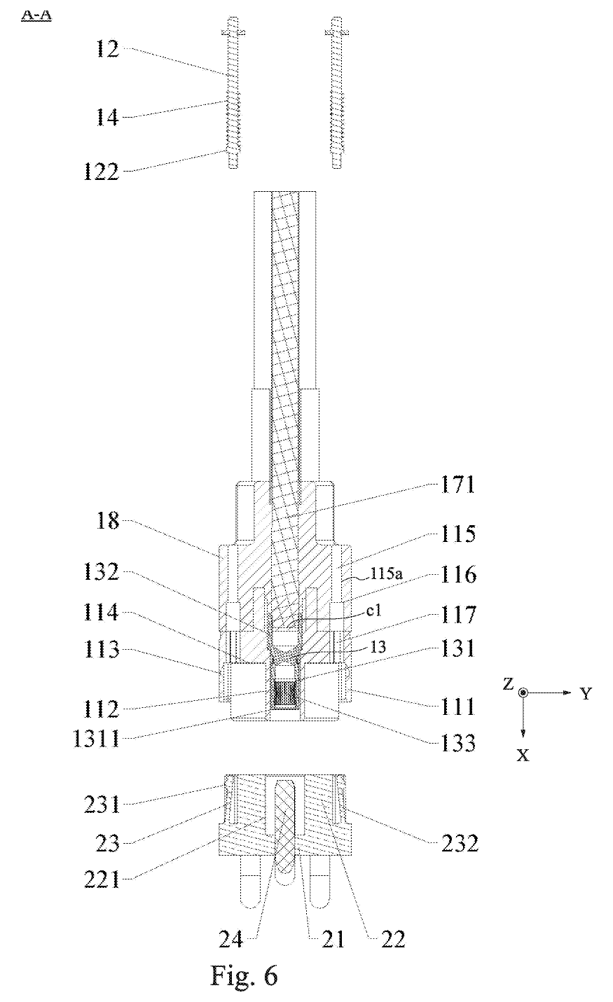

Reference is made to FIGS. 5 and 6. FIG. 5 is a cross-sectional view of the connector assembly 3 taken along section line A-A in FIG. 1. FIG. 6 is an exploded view of the connector assembly 3 in FIG. 5. As shown in FIGS. 5 and 6, and with reference to FIG. 3, in the present embodiment, the terminal 13 includes a front cup-shaped recess 131 and a rear cup-shaped recess 132. The cable 171 electrically connects to the rear cup-shaped recess 132 to transmit current or data. An annular resilient terminal 133 is disposed in the front cup-shaped recess 131 to receive the terminal 24 and to accommodate frequent insertion and removal of the terminal 24. In the present embodiment, an end of the front cup-shaped recess 131 distal from the rear cup-shaped recess 132 includes an extending portion 1311. The extending portion 1311 extends radially (i.e., extends inward toward a center of the front cup-shaped recess 131) and is configured to secure the annular resilient terminal 133 within the front cup-shaped recess 131.

Reference is made to FIG. 4. FIG. 4 is a rear perspective view of the board-end connector assembly 2 in FIG. 1. As shown in FIGS. 3 and 4, in the present embodiment, the board-end connector assembly 2 includes a panel 21, a housing 22, terminal passages 221, and the terminals 24. The housing 22 is disposed on the panel 21. The terminal passages 221 are defined in the housing 22. The terminals 24 are disposed within the terminal passages 221 respectively and extend through the housing 22. In the present embodiment, the cable-end connector assembly 1 and the board-end connector assembly 2 may be assembled and disassembled through the interaction between an engaging member 23, an engaging groove 113, and a limiting member 12, which will be further explained below.

As shown in FIGS. 3 and 4, in the present embodiment, the cable-end connector assembly 1 further includes two engaging grooves 113, and the board-end connector assembly 2 further includes two engaging members 23. Specifically, the two engaging grooves 113 are respectively disposed on two opposite sides of the surrounding wall portion 111 adjacent to the slot 114 (i.e., an inner wall of the surrounding wall portion 111). The two engaging members 23 are respectively disposed on two opposite sides of the housing 22 adjacent to the panel 21 and are configured to be engaged with the two engaging grooves 113, thereby detachably connecting the cable-end connector assembly 1 and the board-end connector assembly 2, but the disclosure is not limited in this regard. In some embodiments, a number of the engaging groove 113 and a number of the engaging member 23 are one or more. In the present embodiment, the engaging member 23 has an arm 232 with an smooth surface facing the housing 22, and the board-end connector assembly 2 further includes a hook 231 located on a side of the engaging member 23 distal from the housing 22. In the present embodiment, the hook 231 is configured to detachably hook the engaging groove 113. In the present embodiment, the engaging groove 113 may be a shallow groove or a through hole.

As shown in FIGS. 5 and 6, and with reference to FIGS. 2 and 3, in the present embodiment, the cable-end connector assembly 1 further includes an insulating body 18 and two through openings 115. The insulating body 18 is fixed to a side of the housing 11 distal from the front portion 11a and covers a connection interface c1 between the cable bundle 17 and the terminals 13. The two through openings 115 pass sequentially through the insulating body 18 and the housing 11, and communicate with the insulating body 18 and the slot 114. In the present embodiment, the cable-end connector assembly 1 further includes two limiting members 12 disposed at the front portion 11a of the housing 11 and movably received in the slot 114. Specifically, the two limiting members 12 are movably disposed in the two through openings 115 respectively. The two limiting members 12 are substantially perpendicular to the front portion 11a and pass through the housing 11. In the present embodiment, when the hook 231 is located in the engaging groove 113, the engaging member 23 is located between the limiting member 12 and the engaging groove 113. In other words, the limiting member 12 may prevent the hook 231 on the engaging member 23 from disengaging from the engaging groove 113.

As shown in FIGS. 5 and 6, and with reference to FIG. 2, in the present embodiment, the cable-end connector assembly 1 further includes a step 116, a spring 14, and a limiting ring 122. The step 116 is disposed within the through opening 115. Specifically, an aperture of the through opening 115 may gradually decrease from the housing 11 to the insulating body 18 to form the step 116. In the present embodiment, the limiting ring 122 is disposed at an end of the limiting member 12 near the slot 114. A width of the limiting ring 122 in the Z-axis may be greater than a width of the limiting member 12 in the Z-axis, so that the limiting member 12 may be stopped at the housing 22 by the limiting ring 122. In the present embodiment, the spring 14 is disposed on a periphery of the limiting member 12, and two ends of the spring 14 abut against the limiting ring 122 and the step 116 respectively. In other words, when the limiting member 12 moves away from the slot 114 along the X-axis, the spring 14 may be stopped at the step 116 to prevent the limiting member 12 from disengaging from the through opening 115, and the elastic potential energy of the spring 14 may gradually accumulate.

As shown in FIGS. 2, 5 and 6, in the present embodiment, the cable-end connector assembly 1 further includes an anti-rotation groove 117 and an anti-rotation block 123. The anti-rotation groove 117 is disposed on an inner wall 115a of the through opening 115. The anti-rotation block 123 is disposed on an outer edge of the limiting ring 122 and is configured to slide against the anti-rotation groove 117. Therefore, the anti-rotation groove 117 and the anti-rotation block 123 may prevent the limiting member 12 from rotating improperly during operation. In the present embodiment, the cable-end connector assembly 1 further includes a pull ring 15 and a pull bar 16. The pull ring 15 is connected to an end of each of the two limiting members 12 distal from the slot 114, and the pull bar 16 is connected to the pull ring 15. In the present embodiment, an operator may pull the pull bar 16 along the X-axis, thereby actuating the pull ring 15, so that the limiting member 12 may move closer to or further away from the slot 114 along the X-axis. In the present embodiment, the insulating body 18 includes a stop protrusion 181. The operator may first hook the pull ring 15 onto the stop protrusion 181, and then pull out the cable-end connector assembly 1.

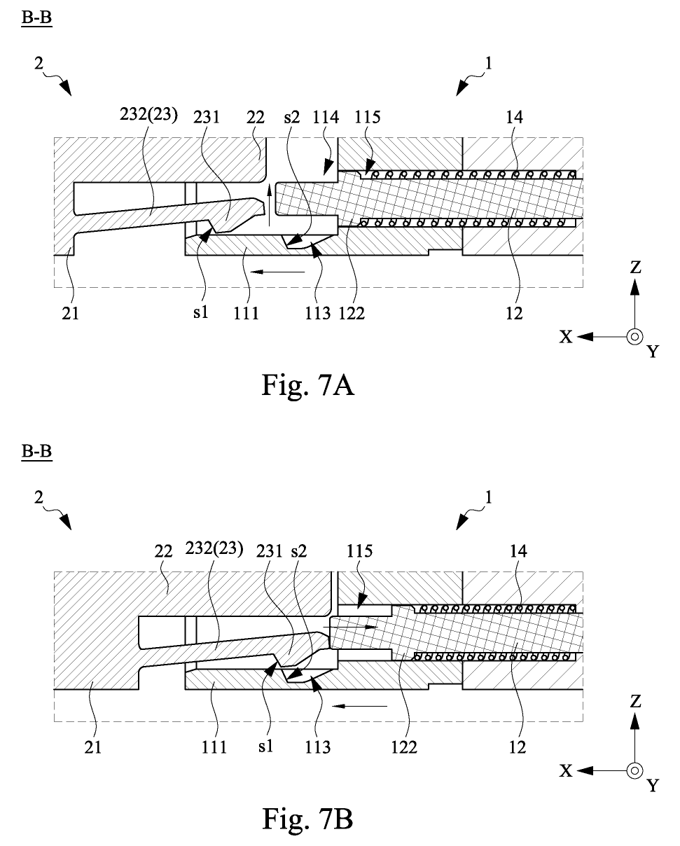

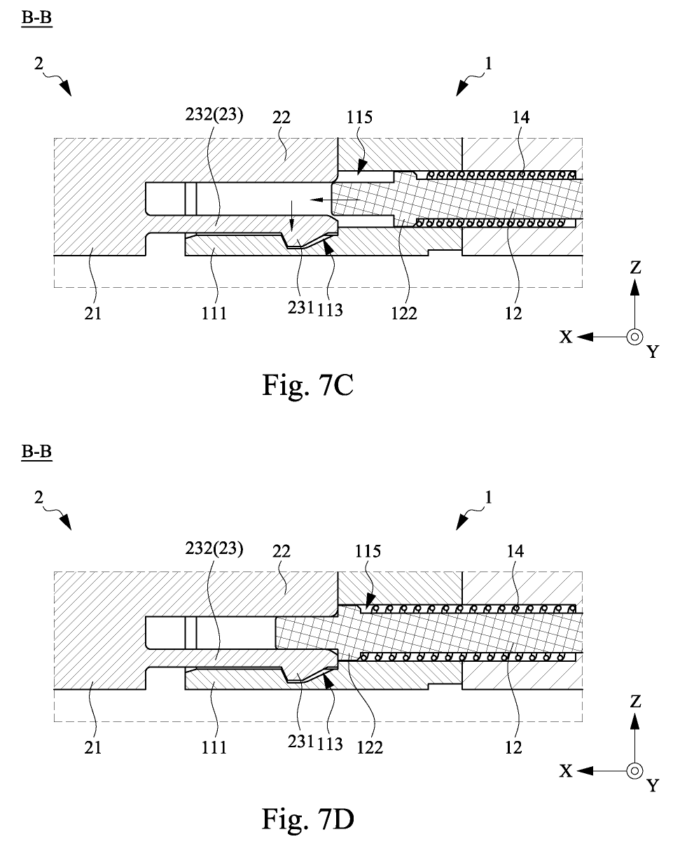

Reference is made to FIGS. 7A-7D. FIGS. 7A-7D are cross-sectional views of the connector assembly 3 taken along section line B-B in FIG. 1, illustrating operation steps for engaging the cable-end connector assembly 1 with the board-end connector assembly 2. As shown in FIGS. 7A-7D, and with reference to FIG. 2, in the present embodiment, as the cable-end connector assembly 1 approaches the board-end connector assembly 2 (see FIG. 7A), the engaging member 23 is pushed towards the housing 22 by the surrounding wall portion 111. As the engaging member 23 enters the slot 114, the engaging member 23 pushes the limiting member 12 into the through opening 115, at which point the spring 14 may gradually accumulate elastic potential energy (see FIG. 7B). When the hook 231 on the engaging member 23 falls into the engaging groove 113 (see FIG. 7C), the gap between the engaging member 23 and the housing 22 allows the limiting member 12 to reset and gradually move towards the board-end connector assembly 2. Finally, the limiting member 12 is located on a side of the engaging member 23 distal from the engaging groove 113, thereby preventing the engaging member 23 from disengaging. In the present embodiment, the hook 231 has a guide slope s1, and the engaging groove 113 has a guide slopes2. The operator may first pull the pull bar 16 to retract the limiting member 12 back into the through opening 115, and then pull the cable-end connector assembly 1 to slide the guide slope s1 along the guide slope s2, thereby causing the engaging member 23 to disengage from the engaging groove 113.

As shown in FIGS. 3 and 4, in the present embodiment, the housing 22 includes a stepped portion 222 inwardly recessed. The stepped portion 222 is located on a side of the housing 22 adjacent to the panel 21, and the engaging member 23 is located in the stepped portion 222. In the present embodiment, the stepped portion 222 is defined between the panel 21 and the housing 22. Specifically, the panel 21 has a surface 21a substantially perpendicular to the X-axis, and the housing 22 has a surface 22a substantially perpendicular to the X-axis. The surfaces 21a and 22a face the cable-end connector assembly 1, with the surface 22a being closer to the cable-end connector assembly 1 than the surface 21a. The housing 22 further has surfaces 22b1 and 22b2 substantially perpendicular to the Y-axis. The surfaces 22b1 and 22b2 face the surrounding wall portion 111, with the surface 22b1 being closer to the surrounding wall portion 111 than the surface 22b2. In the present embodiment, the engaging member 23 is disposed on the surface 21a of the panel 21, and the arm 232 faces the surface 22b2 of the housing 22.

As shown in FIGS. 3 and 4, in the present embodiment, the surrounding wall portion 111 includes a first recessed portion 118, and the housing 22 includes a second recessed portion 25. A portion of the first recessed portion 118 is located between adjacent two of the protruding insulating portions 112. A portion of the second recessed portion 25 is located between adjacent two of the terminal passages 221. In the present embodiment, the board-end connector assembly 2 further includes mounting holes 26 and internally threaded metal elements 27. The mounting holes 26 are disposed on the panel 21, and the internally threaded metal elements 27 are disposed in the mounting holes 26 respectively. In the present embodiment, the mounting holes 26 are exposed in the stepped portion 222 and the second recessed portion 25. Therefore, the board-end connector 2 may be fixed to an interface panel (not shown) by securing fastening members (not shown) to the internally threaded metal elements 27 of the mounting holes 26.

According to the foregoing embodiments of the disclosure, in the connector assembly and its cable-end connector assembly and board-end connector assembly of the present disclosure, by setting the engaging groove and the engaging member in the slot, the external operating space of the connector assembly may be increased. Therefore, multiple connector assemblies may be densely arranged when they are simultaneously plugged into an electronic device. By using the pull ring and the pull bar connected to the limiting member, the space behind the connector assembly may be used to separate the cable-end connector assembly and the board-end connector assembly.

Although the present disclosure has been described in considerable detail with reference to certain embodiments, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations provided they fall within the scope of the following claims.

What is claimed is:

1. A cable-end connector assembly, comprising:
a housing comprising a front portion, a surrounding wall portion, and a plurality of protruding insulating portions disposed on the front portion, wherein a slot is defined between the surrounding wall portion and the protruding insulating portions;
a plurality of terminals respectively disposed within the protruding insulating portions;
at least one engaging groove disposed on a side of the surrounding wall portion adjacent to the slot; and
at least one limiting member disposed at the front portion of the housing and movably received in the slot.

2. The cable-end connector assembly of claim 1, wherein the at least one limiting member is substantially perpendicular to the front portion and passes through the housing.

3. The cable-end connector assembly of claim 1, further comprising a cable bundle, wherein each of the terminals comprises a front cup-shaped recess and a rear cup-shaped recess, and the cable bundle comprises cables electrically connected to the rear cup-shaped recesses respectively.

4. The cable-end connector assembly of claim 3, further comprising an annular resilient terminal, wherein an end of the front cup-shaped recess distal from the rear cup-shaped recess comprises an extending portion, and the extending portion extends radially and is configured to secure the annular resilient terminal within the front cup-shaped recess.

5. The cable-end connector assembly of claim 3, further comprising an insulating body fixed to a side of the housing distal from the front portion and covering a connection interface between the cable bundle and the terminals.

6. The cable-end connector assembly of claim 5, further comprising at least one through opening communicating with the insulating body and the slot, wherein the at least one limiting member is movably disposed in the at least one through opening.

7. The cable-end connector assembly of claim 6, further comprising a limiting ring, a step, and a spring, wherein the limiting ring is disposed at an end of the at least one limiting member near the slot, the step is disposed within the at least one through opening, and the spring is disposed on a periphery of the at least one limiting member and abuts against the limiting ring and the step.

8. The cable-end connector assembly of claim 7, further comprising an anti-rotation groove and an anti-rotation block, wherein the anti-rotation groove is disposed on an inner wall of the at least one through opening, and the anti-rotation block is disposed on an outer edge of the limiting ring and is configured to slide against the anti-rotation groove.

9. The cable-end connector assembly of claim 1, further comprising a pull ring and a pull bar, wherein a number of the at least one limiting member is two, the pull ring is connected to an end of each of the two limiting members distal from the slot, and the pull bar is connected to the pull ring.

10. The cable-end connector assembly of claim 9, further comprising an insulating body fixed to a side of the housing distal from the front portion, wherein the insulating body comprises a stop protrusion, and the pull ring is configured to hook onto the stop protrusion.

11. The cable-end connector assembly of claim 1, wherein the surrounding wall portion comprises a recessed portion, and at least one portion of the recessed portion is located between adjacent two of the protruding insulating portions.

12. A board-end connector assembly, comprising:
a panel;
a housing disposed on the panel;
a plurality of terminal passages defined in the housing;
a plurality of terminals disposed within the terminal passages respectively and extending through the housing;
at least one engaging member disposed on a side of the housing adjacent to the panel, the at least one engaging member having an arm facing the housing; and
at least one hook located on a side of the at least one engaging member distal from the housing.

13. The board-end connector assembly of claim 12, wherein the housing comprises a recessed portion, and at least one portion of the recessed portion is located between adjacent two of the terminal passages.

14. The board-end connector assembly of claim 13, wherein the housing comprises a stepped portion inwardly recessed, the stepped portion is located on the side of the housing adjacent to the panel, and the at least one engaging member is located in the stepped portion.

15. The board-end connector assembly of claim 14, further comprising mounting holes and internally threaded metal elements, wherein the mounting holes are disposed on the panel, the internally threaded metal elements are disposed in the mounting holes respectively, and the mounting holes are exposed in the stepped portion and the recessed portion.

16. A connector assembly, comprising:
a cable-end connector assembly, comprising:
a cable-end housing comprising a front portion, a surrounding wall portion, and a plurality of protruding insulating portions disposed on the front portion, wherein a slot is defined between the surrounding wall portion and the protruding insulating portions;
a plurality of cable-end terminals respectively disposed within the protruding insulating portions;
at least one engaging groove disposed on a side of the surrounding wall portion adjacent to the slot; and
at least one limiting member disposed at the front portion of the cable-end housing and movably received in the slot; and
a board-end connector assembly configured to be inserted into the cable-end connector assembly, and comprising:
a panel;
a board-end housing disposed on the panel;
a plurality of terminal passages defined in the board-end housing;
a plurality of board-end terminals disposed within the terminal passages respectively and extending through the board-end housing;
at least one engaging member disposed on a side of the board-end housing adjacent to the panel, the at least one engaging member having an arm facing the board-end housing; and
at least one hook located on a side of the at least one engaging member distal from the board-end housing and being configured to detachably hook the at least one engaging groove;
wherein when the at least one hook is located in the at least one engaging groove, the at least one engaging member is located between the at least one limiting member and the at least one engaging groove.

17. The connector assembly of claim 16, further comprising an insulating body fixed to a side of the cable-end housing distal from the front portion, wherein the cable-end connector assembly further comprises at least one through opening communicating with the insulating body and the slot, and the at least one limiting member is movably disposed in the at least one through opening.

18. The connector assembly of claim 17, wherein the cable-end connector assembly further comprises a limiting ring, a step, and a spring, wherein the limiting ring is disposed at an end of the at least one limiting member near the slot, the step is disposed within the at least one through opening, and the spring is disposed on a periphery of the at least one limiting member and abuts against the limiting ring and the step.

19. The connector assembly of claim 16, wherein a number of the at least one limiting member is two, the cable-end connector assembly further comprises a pull ring and a pull bar, the pull ring is connected to an end of each of the two limiting members distal from the slot, and the pull bar is connected to the pull ring.

20. The connector assembly of claim 16, wherein the surrounding wall portion comprises a first recessed portion, the board-end housing comprises a second recessed portion, at least one portion of the first recessed portion is located between adjacent two of the protruding insulating portions, and at least one portion of the second recessed portion is located between adjacent two of the terminal passages.
